(19) United States
(12) Patent Application Publication
(10) Pub. No.: US 2009/0261612 A1
(43) Pub. Date: Oct. 22, 2009

(54) INSTRUMENT PANEL DEVICE

(75) Inventors: Masatoshi TAKAYAMA, Hiroshima (JP); Toshinori TOYOHARA, Hiroshima (JP); Kazuhiro TANAKA, Hiroshima (JP); Kazunori IKURA, Hiroshima (JP); Yasuaki OKAZAKI, Hiroshima (JP); Hitoshi OCHIMIZU, Hiroshima (JP)

Correspondence Address: Studebaker & Brackett PC, 1890 Preston White Drive, Suite 105, Reston, VA, 20191, US

(73) Assignee: MAZDA MOTOR CORPORATION, Hiroshima (JP)

(21) Appl. No.: 12/426,387

(22) Filed: Apr. 20, 2009

(30) Foreign Application Priority Data
Apr. 22, 2008 (JP) 2008-111675
Apr. 22, 2008 (JP) 2008-111676
Apr. 22, 2008 (JP) 2008-111677
Apr. 22, 2008 (JP) 2008-111678
Apr. 22, 2008 (JP) 2008-111679
Dec. 26, 2008 (JP) 2008-332403

(51) Int. Cl. B60K 37/02; B60K 37/04

(52) U.S. Cl. 296/70; 180/90

(57) ABSTRACT

An instrument panel device comprises an instrument panel body, a meter cluster portion, a display indication portion, an instrument-panel recess portion comprising a bottom face portion extending from a central portion of the recess portion to a driver's-seat-side end portion of the recess portion and a portion of difference in level which rises upward from a front end portion of the bottom face portion, a projection portion provided in front of the steering wheel, the projection portion being formed in such a manner that a specified portion of the bottom face portion of the recess portion which is located in front of the steering wheel projects upward. A meter-panel face portion of the meter cluster portion is provided at the projection portion. The display indication portion is provided at a central portion of the portion of difference in level.

### BACKGROUND OF THE INVENTION

The present invention relates to an instrument panel device which is provided at a front portion of a vehicle compartment so as to project rearward and extend in a vehicle width direction.

Conventionally, as disclosed in Japanese Patent Laid-Open Publication No. 2005-297657, an instrument panel structure of an automotive vehicle which comprises an upper meter and a lower meter which are supported at a front upper portion and a rear lower portion of an instrument panel body respectively, and an upper panel and a lower panel which are detachably attached to the instrument panel body so as to enclose the upper meter and the lower meter respectively is known. Herein, the upper meter and the lower meter are disposed in front of a steering wheel at respective positions which correspond to an upper part and a lower part of an upper half portion of the steering wheel. Further, the upper panel is disposed in such a manner that an upper edge of the upper panel is located along the upper half portion of the steering wheel.

The instrument panel structure of an automotive vehicle disclosed in the above-described publication has an advantage that a driver can properly see the upper and lower meters without interruption by the steering wheel. On the other hand, in case the size of these meter portions is made larger in order to further improve the visibility of the meters, it may not be avoided that the upper end of the meter portion becomes higher, so that the front view of the driver would be improperly limited or the driver would feel a sense of oppression.

Further, in case the driver tries to see both the upper meter and the lower meter, seeing the front through a windshield, there may be another problem in that it would be difficult for the driver to recognize displays indicated by the meters promptly and properly because the upper and lower meters are seen vertically continuously.

### SUMMARY OF THE INVENTION

The present invention has been devised in view of the above-described problems, and an object of the present invention is to provide an instrument panel device which can provide a proper visibility of the meters provided at the instrument panel, without improperly limiting the front view of the driver or making the driver feel the sense of oppression.

According to the present invention, there is provided an instrument panel device, comprising an instrument panel body provided at a front portion of a vehicle compartment so as to project rearward and extend in a vehicle width direction, a meter cluster portion provided in front of a steering wheel, a display indication portion to indicate information relating to an onboard device, an instrument-panel recess portion provided at an upper face portion of the instrument panel body, the instrument-panel recess portion comprising a bottom face portion which extends from a central portion of the instrument-panel recess portion to a driver's-seat-side end portion of the recess portion and a portion of difference in level which rises upward from a front end portion of the bottom face portion, a projection portion provided in front of the steering wheel, the projection portion being formed in such a manner that a specified portion of the bottom face portion of the instrument-panel recess portion which is located in front of the steering wheel projects upward, wherein a meter-panel face portion of the meter cluster portion is provided at the projection portion, and the display indication portion is provided at a central portion of the portion of difference in level in the vehicle width direction.

According to the present invention, it can be prevented that the position of the upper ends of the meter cluster portion and the display indication portion become improperly high, ensuring the properly large sizes of the meter cluster portion and the display indication portion. Thus, the meter panel of the cluster meter portion and the information indicated at the display indication portion can be seen properly by the driver, without improperly limiting the front view of the driver or making the driver feel the sense of oppression.

According to another embodiment of the present invention, the instrument panel device further comprises an instrument-panel protrusion portion provided at the upper face portion of the instrument panel body, the instrument-panel protrusion portion forming an upper face of the instrument-panel recess portion. Thus, the meter panel of the cluster meter portion and the information indicated at the display indication portion can be seen properly by the driver, without improperly limiting the front view of the driver or making the driver feel the sense of oppression.

According to another embodiment of the present invention, the instrument-panel protrusion portion has a peak point which is the highest of the upper face portion of the instrument panel body, and the display indication portion is located substantially on a center side of the vehicle compartment from the peak point of the instrument-panel protrusion portion. Thereby, the meter cluster portion and the information displayed at the display indication portion can be seen more properly by the driver, without improperly limiting the front view of the driver or making the driver feel the sense of oppression.

According to another embodiment of the present invention, the instrument panel device further comprises an instrument-panel rearward-slant-face portion provided at the upper face portion of the instrument panel body, the instrument-panel rearward-slant-face portion being formed so as to gently slant rearward over a substantially whole area of the upper face portion of the instrument panel body in the vehicle width direction in such a manner a central portion thereof extends rearward the most, wherein the central portion of the instrument-panel rearward-slant-face portion is connected to a center console portion which comprises an operational portion of an onboard device, and the display indication portion is provided at a specified portion of the portion of difference in level which is located substantially in front of the center console portion, the display indication portion pointing to a driver's seat side in a plan view. Thereby, an inner space and an upper space of the instrument panel, particularly, the central portion of the instrument panel can be ensured properly, without improperly limiting spaces for the driver's seat and the passenger's seat. Thus, various onboard devices can be disposed by effectively using the inner space of the instrument panel, and the display indication portion and the like can be disposed at a proper position by effectively using the upper space of the instrument panel. Further, since the display indication portion is provided at the specified portion of the portion of difference in level which is located substantially in front of the center console portion in such a manner that the display indication portion points to the driver's seat side in the plan view, the proper visibility of the display indication portion can be ensured, without improperly limiting the front view of the driver and any other problems.

According to another embodiment of the present invention, the portion of difference in level of the instrument-panel recess portion and the center console portion form a designed face, which is of a substantially reverse-J shape, which extends continuously from a driver's-seat-side portion to the center console portion beyond the central portion of the instrument-panel recess portion in such a manner that the portion of difference in level of the instrument-panel recess portion projects forward in a plan view. Thereby, the driver who drives the vehicle looking at the front can see the information indicated at the display indication portion and the information of the operational portion of the onboard device at the center console portion continuously and properly by moving the driver's eyes from the side portion to the lower portion, so that the driver can properly operate the operational portion of the onboard device.

According to another embodiment of the present invention, the center console portion is provided so as to project upward in a mountain shape in a side view in such a manner that a front-upper end portion thereof connects to a rear end of the instrument-panel recess portion and an onboard device is stored therein. Thereby, since an inner space with a large volume can be formed at a lower portion, various onboard devices may be disposed properly by using the inner space of this mountain-shaped portion.

According to another embodiment of the present invention, the center console portion has a rear wall face which extends obliquely rearward and downward, an onboard device which is of a substantially rectangular parallelepiped shape is disposed in the central console portion along the rear wall face, and another onboard device is disposed in the central console portion before the onboard device which is of the substantially rectangular parallelepiped shape. Thereby, a navigation device or the like, as the onboard device which is of the substantially rectangular parallelepiped shape, can be disposed easily in such a manner that its display is inclined so as to be seen properly, preventing a gap from existing between the navigation device or the like and the center console portion. Further, by disposing another onboard device in the central console portion before the above-described navigation device or the like, various onboard devices may be disposed effectively by using the inner space of the mountain-shaped portion.

According to another embodiment of the present invention, a speaker of an audio device is disposed at a front portion in the center console portion, a ventilation duct of an air-conditioning unit is disposed in the center console portion behind the speaker, and the onboard device which is of the substantially rectangular parallelepiped shape is disposed below the ventilation duct. Thereby, a common layout of the air-conditioning unit can be provided regardless of the kind of vehicles with a left-side-disposition steering wheel for Europe markets or the like, or vehicles with a right-side-disposition steering wheel for Japanese markets or the like. Thus, various onboard devices may be disposed properly at the inner space of the mountain-shaped portion, improving commonality of the instrument panel device effectively.

According to another embodiment of the present invention, an onboard functional portion is provided at a specified portion of the portion of difference in level of the instrument-panel recess portion which is located at a position which overlaps with the meter cluster portion in an elevation view. Thereby, the specified portion of the portion of difference in level of the instrument-panel recess portion which is located at the position which overlaps with the meter cluster portion in the elevation view can be used effectively, so that the use efficiency of the instrument panel space can be improved.

According to another embodiment of the present invention, the portion of difference in level of the instrument-panel recess portion has a different design from a surrounding part of the upper face portion of the instrument panel body. Thereby, the sporty feeling can be provided to the driver more effectively, for example, by improving the design effect of the vehicle compartment.

According to another embodiment of the present invention, an air-conditioning unit is stored right below the display indication portion, and an onboard device is disposed right behind the air-conditioning unit at a position which overlaps with the air-conditioning unit in an elevation view. Thereby, the air-conditioning unit and another onboard device such as the navigation device can be disposed efficiently, by using the relatively large volume of the inner space formed below the instrument panel.

According to another embodiment of the present invention, a vent for defroster is provided at a front portion of the upper face portion of the instrument panel body, an air-conditioning unit is stored right below the display indication portion, and a defroster opening for supplying conditioning air from the air-conditioning unit to the vent for defroster is formed at the instrument panel body in such a manner that at least a part of the defroster opening does not overlap with the display indication portion in a plan view. Thereby, the flowing of conditioning air can be made smooth, preventing the conditioning air passing through the vent for defroster from interfering with the display indication portion.

According to another embodiment of the present invention, a part of the defroster opening vent for defroster which is located further from a driver's seat in the vehicle width direction does not overlap with the display indication portion in the plan view. Thereby, even in case a device with a large volume is stored at the display indication portion, the flowing of the conditioning air can be made smooth, disposing the device in the display indication portion. For example, in case the navigation device with the relatively large volume is stored, the navigation device may be properly disposed on the side of the driver's seat.

According to another embodiment of the present invention, a navigation device is provided at a part of the display indication portion which is located closer to the driver's seat. Thus, for example, in case the navigation device with the relatively large volume is stored, the navigation device may be properly disposed on the side of the driver's seat.

According to another embodiment of the present invention, a vent to supply conditioning air to a side portion of the vehicle compartment is formed at a side portion of the instrument panel body, and a ventilation duct to supply the conditioning air from an air-conditioning unit, which is stored right below the display indication portion, to the vent is provided so as to extend in the vehicle width direction in front of the meter cluster portion and below the portion of difference in level. Thereby, the volume of the ventilation duct can be ensured properly, avoiding the interference of the ventilation duct and meter cluster portion and the like.

Other features, aspects, and advantages of the present invention will become apparent from the following description which refers to the accompanying drawings.

### BRIEF DESCRIPTION OF THE DRAWINGS

FIG. 1 is a perspective view showing an instrument panel device according to a first embodiment of the present invention.

FIG. 2 is a view of the instrument panel device according to the first embodiment, when viewed from a driver's seat.

FIG. 3 is a plan view showing a specific structure of the instrument panel device according to the first embodiment.

FIG. 4 is a sectional view taken along line IV-IV of FIG. 3.

FIG. 5 is a plan sectional view showing specific structures of a meter cluster portion and a display indication portion according to the first embodiment.

FIG. 6 is an explanatory diagram showing a specific structure of the display indication portion according to the first embodiment.

FIG. 7 is a sectional view taken along line VII-VII of FIG. 3.

FIG. 8 is a perspective view showing an inner structure of an instrument panel according to the first embodiment.

FIG. 9 is a plan sectional view showing a disposition state of an onboard device according to the first embodiment.

FIG. 10 is an explanatory diagram showing an information perception characteristic based on a position of retinas of a person.

FIG. 11 is a view of the instrument panel device, which corresponds to FIG. 2, with a mark of a move of driver's eyes.

FIG. 12 is a view of an instrument panel device according to a second embodiment, when viewed from the driver's seat.

FIG. 13 is a plan view showing a specific structure of the instrument panel device according to the second embodiment.

FIG. 14 is a sectional view taken along line XIV-XIV of FIG. 13.

FIG. 15 is a sectional view taken along line XV-XV of FIG. 13.

FIG. 16 is a plan sectional view showing specific structures of a meter cluster portion and a display indication portion according to the second embodiment.

FIG. 17 is an explanatory diagram showing a specific structure of the display indication portion according to the second embodiment.

FIG. 18 is a sectional view taken along line XVII-XVII of FIG. 13.

FIG. 19 is a perspective view showing an inner structure of an instrument panel according to the second embodiment.

### DETAILED DESCRIPTION OF THE INVENTION

Hereinafter, preferred embodiments of the present invention will be described referring to the accompanying drawings.

### Embodiment 1

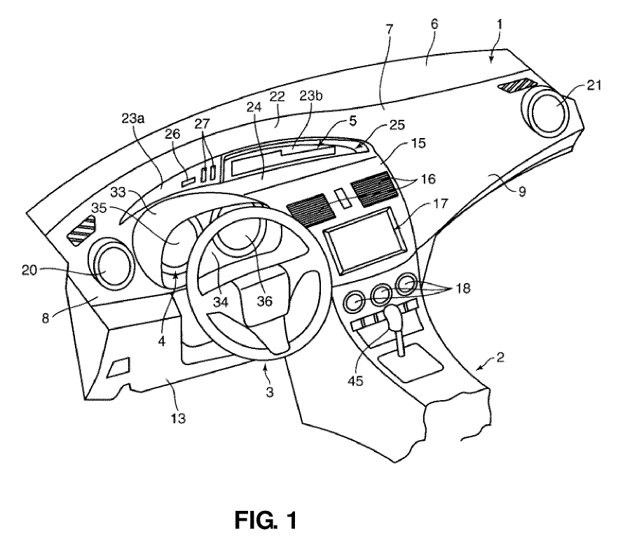

FIGS. 1 through 4 show an instrument panel device according to a first embodiment of the present invention. This instrument panel device comprises an instrument panel body 1 which is provided at a front portion of a vehicle compartment so as to project rearward and extend in a vehicle width direction, a center console portion 2 which is provided so as to extend downward from a central portion of the instrument panel body 1 toward a bottom portion of the vehicle compartment, a meter cluster portion 4 which is provided in front of a steering wheel 3 to be operated by a driver, and a display indication portion 5 which indicates information relating to onboard devices which will be described later. Herein, a driver's seat is located on the left in the vehicle compartment, and the steering wheel 3 is disposed on the left accordingly.

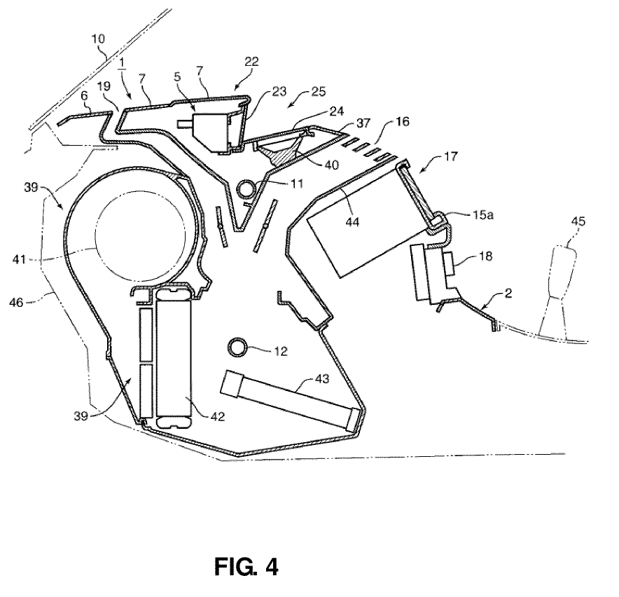

The instrument panel body 1 comprises a front portion 6 which extends substantially horizontally in the vehicle width direction along a lower end portion of a windshield 10, an upper face portion 7 which connects to a rear end portion of the front portion 6, and a pair of right and left rearward-slant-face portions 8, 9 which is provided in back of the upper face portion 7 so as to gently slant rearward over a substantially whole width. The instrument panel body 1, which is made of synthetic resign material or the like, is supported at upper and lower cross beams 11, 12 which are provided so as to extend in the vehicle width direction via brackets (not illustrated) or the like. Reference numeral 46 denotes a dash panel in FIG. 4.

A lower plate 13 which hides base portions of a steering shaft and various pedals and protects knees and the like of the driver at a vehicle frontal collision is attached on the left side (driver's seat side) of the center console portion 2. A lower plate 14 which includes a lid of a glove box and the like is attached on the right side (passenger's seat side) of the center console portion 2. Thus, the instrument panel is formed. The rearward-slant-face portions 8, 9 and an upper portion 15 of the center console portion 2 form an instrument-panel rearward-slant-face portion which is provided so as to gently slant rearward over the substantially whole width and has a ridgeline in such a manner a central portion thereof in the plan view extends rearward the most (see FIG. 3).

A vent grill 16 which supplies conditioning air and the like to a central portion in the vehicle compartment is provided at the upper portion 15 of the center console portion 2 which forms a central portion of the above-described instrument-panel rearward-slant-face portion. Below the vent grill 16 are provided a navigation device 17 as an onboard device and an operational portion 18 which comprises an operational switch of an air-conditioning unit 39 which will be described later in order. A vent for defroster 19 is provided at the front portion 6 of the instrument panel body 1. Side vents 20, 21 which supply the conditioning air and the like to the side portion in the vehicle compartment are provided at both sides of the rearward-slant-face portions 8, 9.

Further, an instrument-panel protrusion portion 22 is provided at a specified area of the upper face portion 7 of the instrument panel body 1 which extends from the center to a driver's-seat-side end portion thereof. The instrument-panel protrusion portion is formed in a mountain shape in such a manner that it has a highest point at a portion thereof which is close to a driver's-seat-side end portion 2a of the center console portion 2. An instrument-panel recess portion 25 is further provided, which comprises a portion of difference in level 23 which goes down from a rear end portion of the instrument-panel protrusion portion 22 and an instrument-panel bottom face portion 24 which extends obliquely upward and rearward from a lower end of the portion of difference in level 23.

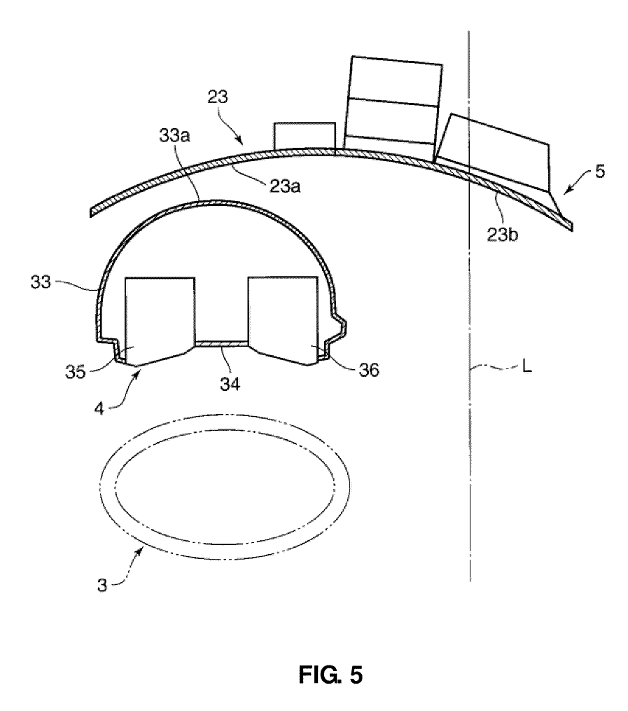

Thus, the instrument-panel recess portion 25 comprises the instrument-panel bottom face portion 24 which extends from the central portion of the instrument-panel recess portion 25 to a driver's-seat-side end portion of the recess portion and extends obliquely upward and rearward and the portion of difference in level 23 which rises upward from a front end portion of the instrument-panel bottom face portion 24. Further, as shown in FIG. 3, a front side portion of the instrument-panel recess portion 25 is formed in a curve shape so as to project forward at its center in a plan view. According to this, as shown in FIG. 5, the portion of difference in level 23 is formed in a curve shape so as to have its side portions which are located rearward. Reference character L denotes a center line in the vehicle width direction in FIG. 5.

The rearward-slant-face portion 8 is connected to a left-side portion of the rear end portion of the instrument-panel recess portion 25 so as to gently slant rearward. The upper portion 15 of the center console portion 2 is connected to a right-side portion of the rear end portion of the instrument-panel recess portion 25. Thus, the portion of difference in level 23 of the instrument-panel recess portion 25 and the center console portion 2 form a designed face, which is of a substantially reverse-J shape, which extends continuously from a driver's-seat-side portion to the center console portion 2 beyond the central portion of the instrument-panel recess portion 25 in such a manner that the portion of difference in level 23 of the instrument-panel recess portion 25 projects forward in the plan view.

The portion of difference in level 23 of the instrument-panel recess portion 25 has a different design from a surrounding part of the upper face portion of the instrument panel body 1 so as to provide a different impression, for example, by applying a different color. In case, for example, the surface of the instrument panel body 1 is formed in a grain shape with a color of dark gray, the portion of difference in level 23 may be formed with a shinny surface as if it looks like an indication display which is switched off. Specifically, a left-side half portion 23a of the portion of difference in level 23 which is located behind an onboard functional portion, which will be described below, has a black panel added, while a right-side half portion 23b of the portion of difference in level 23 which is located behind an illuminator of the display indication portion 5 has a dark glass with a limited transparency. The above-described black panel and dark glass are provided continuously in the vehicle width direction so that the portion of difference in level 23 looks like a display indication portion as a whole.

Further, an onboard functional portion, such as a slot portion 26 for a SD card, a connector 27 of an portable audio device, or a store portion (not illustrated), is provided at the left-side half portion 23a of the portion of difference in level 23 which is located in front of the meter cluster portion 4 as shown in FIG. 1.

The display indication potion 5, which comprises a liquid crystal display to indicate information relating to the onboard devices comprising an air-conditioning unit and an audio unit, is provided at an offset portion of the portion of difference in level 23 from a disposition portion of the onboard functional portion, that is, at the above-described right-side half portion 23b which is formed in a curved shape and inclined so as to point to the driver's seat (left side) in the plan view, which is located on the center side of the highest point of the instrument-panel protrusion portion 22 and in front of the center console portion 2 as shown in FIG. 5.

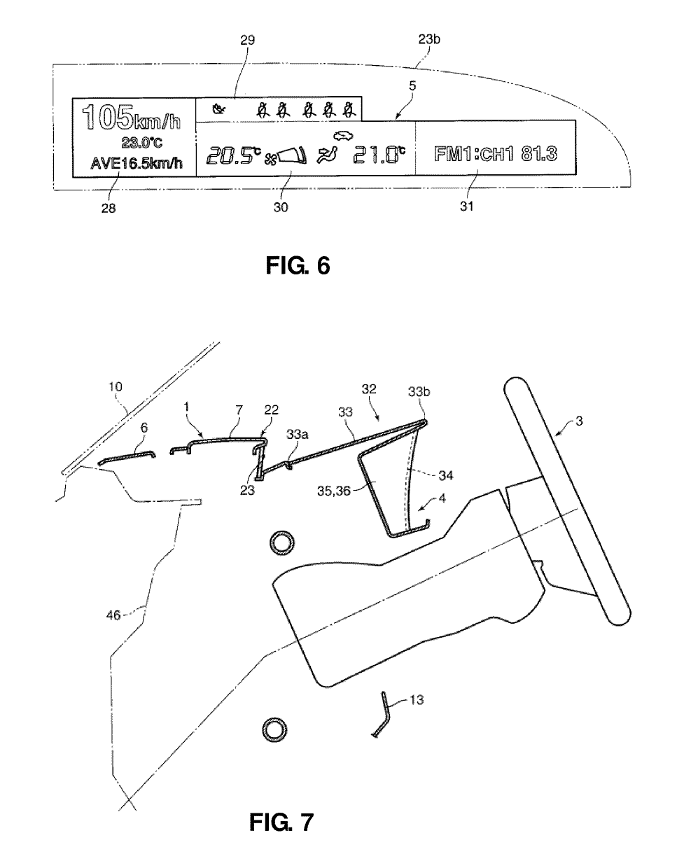

The display indication portion 5 comprises, as shown in FIG. 6, a first indication portion 28 which selectively indicates traveling information, such as an average speed and fuel consumption from DIS (Driver Information System) or the outside temperature, and simplified navigation information without illustration, a second indication portion 29 which indicates warning information relating to a seatbelt and a child seat, a third indication portion 30 which indicates information relating to the air-conditioning unit which comprises an air-conditioning temperature, volume, conditioning-air supply pattern and the like, and a fourth indication portion 31 which indicates information relating to the audio device which comprises an audio source, channel, frequency and the like.

As shown in FIG. 7, a protrusion portion 32 is provided at the bottom face portion 24 of the instrument-panel recess portion 25 which is located on the driver's-seat side of the highest point of the instrument-panel protrusion portion 22 at the upper face portion 7 of the instrument panel body 1. The meter cluster portion 4 is provided at the above-described protrusion portion 32. The meter cluster portion 4 has a meter hood portion 33 which forms an upper wall face of the protrusion portion 32 and a meter-panel face portion 34 which is provided at a specified portion in front of the steering wheel 3 so as to overlap with the steering wheel 3 in an elevation view. A vehicle speed meter 35 and an engine speed meter 36 are provided at the meter-panel face portion 34 so that the important information of the vehicle speed and the engine speed can be indicated properly compared to other information indicated at the display indication portion 5.

The meter hood portion 33 which forms the upper wall face of the protrusion portion 32 is disposed over an area from the instrument-panel recess portion 25, and the rearward-slant-face portion 8 and the meter-panel face portion 34 are disposed at a rear portion of the protrusion portion 32. Thus, the driver seated in the driver's seat can see the vehicle speed meter 35 and the engine speed meter 36 at the meter-panel face portion 34 via an opening which is formed at the upper half portion of the steering wheel 3.

A curve portion 33a is provided at a front end portion of the meter hood portion 33 as shown in FIG. 3 so as to connect to the instrument-panel bottom face portion 24 of the instrument-panel recess portion 25. The instrument-panel bottom face portion 24 is disposed so as to enclose both-side portions of the meter cluster portion 4. Further, the highest point of the meter cluster portion 4, that is, a central portion 33b of the meter hood portion 33 is, as shown in FIG. 7, positioned above the instrument-panel protrusion portion 22.

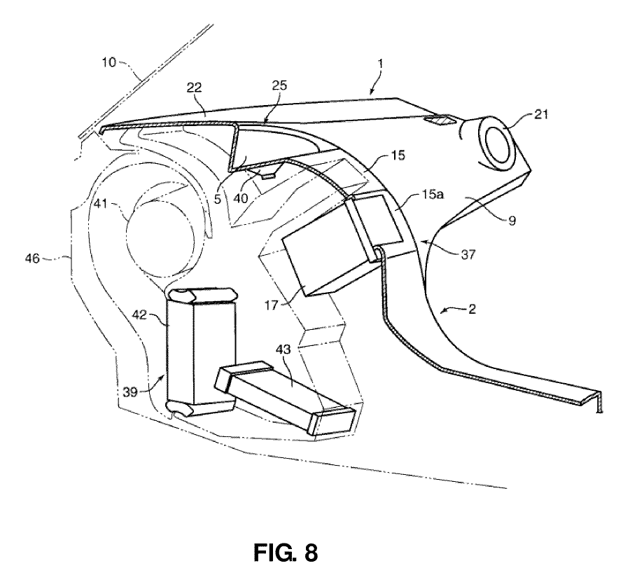

The center console portion 2 which is provided so as to extend downward from the central portion of the instrument panel body 1 is, as shown in FIGS. 4 and 8, provided so as to have a mountain-shaped portion 37 which projects upward in a mountain shape in the side view in such a manner that its front-upper end portion connects to a rear end of the instrument-panel recess portion 25 and various onboard devices are stored in the mountain-shaped portion 37. That is, the upper portion 15 of the center console portion 2 has a rear wall face 15a which extends obliquely rearward and downward, and the navigation device 17 as the onboard device which is of the substantially rectangular parallelepiped shape is disposed in the central console portion 2 along the rear wall face 15a.

Further, other onboard devices which comprise the air-conditioning unit 39 and the speaker of the audio device are disposed between the navigation device 17 and the mountain-shaped portion 37 of the center console portion 37. The air-conditioning unit 39 comprises a blower 41 which is provided at an upper portion thereof, an evaporator 42 and a heater 43 which are provided at a lower portion thereof, and a ventilation duct 44 which connects to the vent grill 16, and it is provided at a central portion in the vehicle width direction.

The air-conditioning unit 39 is disposed in an inner space of the instrument panel right below the display indication portion 5 which is provided on a passenger's-seat-side (right-side) portion of the instrument-panel recess portion 25, that is, an interconnection portion between the central portion of the instrument panel body 1 and the center console portion 2. A speaker 40 of the audio device is disposed at a front portion of the mountain-shaped portion 37, a ventilation duct 44 of the air-conditioning unit 39 is disposed behind the speaker 40, and the navigation device 17 which is the substantially rectangular parallelepiped shape is disposed below the ventilation duct 44.

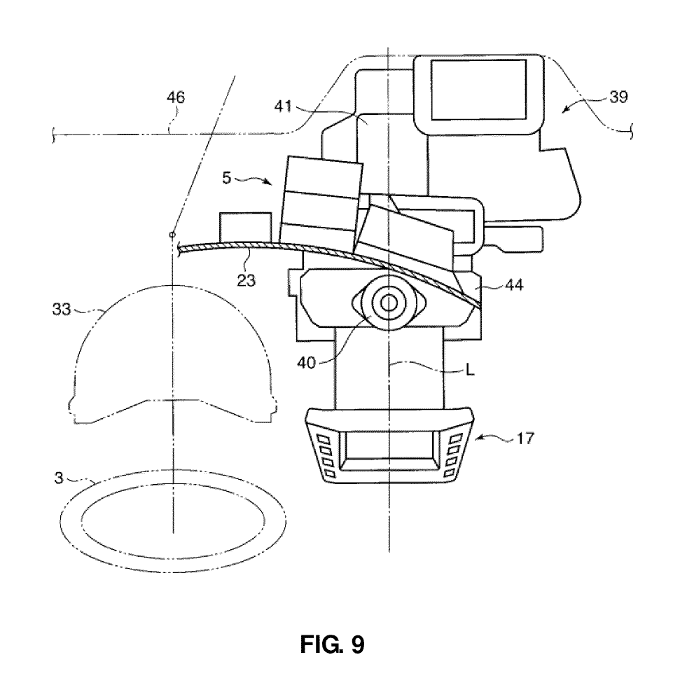

The blower 41 as a major part of the air-conditioning unit 39 and the navigation device 17 are disposed so as to be offset from each other in a vehicle longitudinal direction and substantially at the same height position as shown in FIG. 4. Further, as shown in FIG. 9, the blower 41 and the navigation device 17 are disposed respectively at the central portion of the instrument panel in the vehicle width direction, and the air-conditioning unit 39 and the navigation device 17 are located so as to overlap with each other in the elevation view.

As described above, the instrument panel device according to the present embodiment comprises the instrument panel body 1 which is provided at the front portion of the vehicle compartment so as to project rearward and extend in the vehicle width direction, the meter cluster portion 4 which is provided in front of the steering wheel 3, the display indication portion 5 which indicates information relating to the onboard device, the instrument-panel recess portion 25 which is provided at the upper face portion 7 of the instrument panel body 1, the instrument-panel recess portion 25 comprising the bottom face portion 24 which extends from the central portion of the instrument-panel recess portion 25 to the driver's-seat-side end portion of the instrument-panel recess portion 25 and the portion of difference in level 23 which rises upward from the front end portion of the bottom face portion 24, the projection portion 32 which is provided in front of the steering wheel 3, the projection portion 32 being formed in such a manner that the specified portion of the bottom face portion 24 of the instrument-panel recess portion 25 which is located in front of the steering wheel 3 projects upward, wherein the meter-panel face portion 34 of the meter cluster portion 4 is provided at the projection portion 32, and the display indication portion 5 is provided at the central portion of the portion of difference in level 23 in the vehicle width direction. Thus, the meters and the like at the instrument panel can be seen properly by the driver, without improperly limiting the front view of the driver or making the driver feel the sense of oppression.

That is, according to the present embodiment, the projection portion 32 which has the meter hood portion 33 is formed above the bottom face portion 24 of the instrument-panel recess portion 25 which is provided at the upper face portion 7 of the instrument panel body 1 in front of the driver's seat, the meter-panel face portion 34 of the meter cluster portion 4 at the projection portion 32 is disposed so as to face to the steering wheel 3, and the display indication portion 5 is provided at the central portion of the portion of difference in level 23 which is located in front of the center console portion 2. Thereby, the display indication portion 5 and the meter cluster portion 4 can be located so as to be offset from each other laterally.

Accordingly, it would not be necessary to ensure the proper visibility by disposing the meter cluster portion 4 and the display indication portion 5 offset from each other vertically, so that it can be prevented that the position of the upper end of either of these portions 4, 5 becomes improperly high. Thus, even in case the size of these portions 4, 5 is made large to ensure the proper visibility, the vehicle speed meter 35 and the engine speed meter 36 which are provided at the meter-panel face portion 34 of the meter cluster portion 4 and the various information of the indication portions 28-31 at the display indication portion 5 can be seen properly by the driver, without improperly limiting the front view of the driver or making the driver feel the sense of oppression.

Particularly, in case the bottom face portion 24 of the instrument-panel recess portion 25 where the display indication portion 5 is provided is provided so as to extend obliquely upward and rearward along the direction of the driver's eyes, the visibility can be ensured effectively by lowering the position of a bottom portion of the display indication portion 5 as much as possible. Accordingly, the information indicated at the display indication portion 5 can be seen properly by the driver, without improperly limiting the front view of the driver or making the driver feel the sense of oppression.

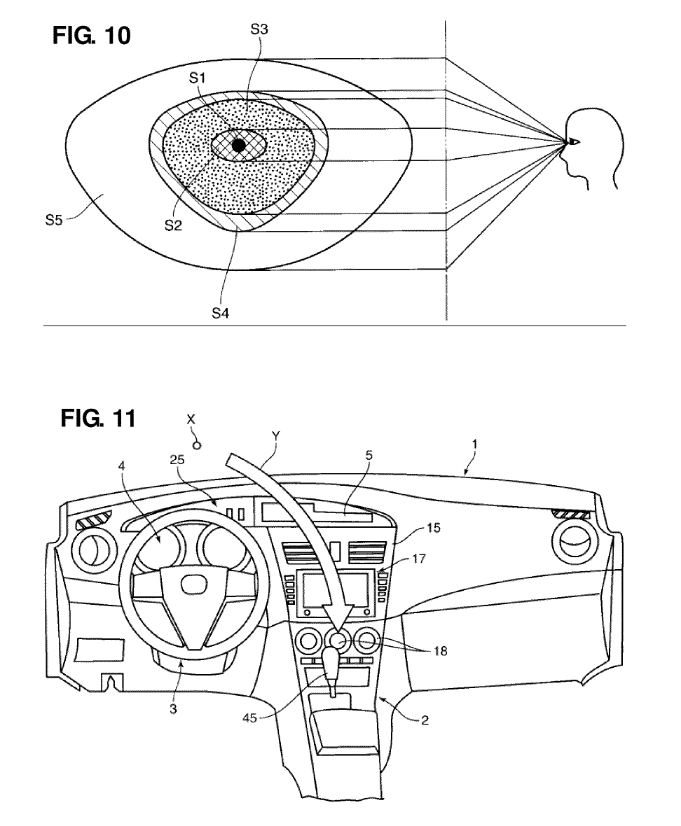

Herein, there is a tendency that the information perception characteristic (field of vision) which is based on the position of retinas of a person deteriorates in accordance with the distance from the center of the retinas. The characteristic comprises, as shown in FIG. 10, a perceptive filed S1 where the visual perception function is superior so as to provide a high information perception, an effective field S2 where the steady gaze of information is possible only with the move of an eyeball so as to perceive particular information quickly, a steady-gaze stable filed S3 where the normal steady gaze of information is possible with assistance of the move of a head for the eyeball's move, an induction field S4 where the existence of information is determinable so as to affect the sense of space perception, and another induction field S5 where the visual perception function is so inferior that only assistant function to provide induction to other sensitive fields is performed. These fields S1-S5 are located circularly as shown in the figure. Herein, there is a tendency that the lateral width of this characteristic is greater than the vertical width of that as shown. Accordingly, the lateral offset disposition of the meter cluster portion 4 and the display indication portion 5, like the present embodiment, can further improve the visibility of the meter cluster portion 4 and the information of the display indication portion 5.

Further, according to the present embodiment, the vehicle speed meter 35 and the engine speed meter 36 are provided at the meter cluster portion 4 located in front of the driver's seat so that the important information of the vehicle speed and the engine speed is indicated. Meanwhile, the relatively less important information, such as the average vehicle speed and fuel consumption form the DIS (Driver Information System), the outside temperature and the like, is indicated at the display indication portion 5 which is located offset from the meter cluster portion 4. In this case, in particular, the driver looking at the front through the windshield can see the important information indicated at the meter cluster portion 4 quickly and easily without moving the driver's eyeball greatly.

According to the present embodiment, the upper portion 15 of the center console portion 2 is connected to the right-side rear end portion of the instrument-panel recess portion 25 where the display indication portion 5 is provided, and the instrument-panel recess portion 25 and the center console portion 2 form the designed face, which is of the substantially reverse-J shape. Thereby, as shown in FIG. 11, the driver who drives the vehicle looking at the front X through the windshield can see the information relating to the onboard devices which are indicated at the display indication portion 5 and the display of the navigation device 17 provided at the upper portion 15 of the center console portion 2 and the like continuously and properly, by moving the driver's eyes from the side portion to the lower portion (see an arrow Y).

Further, the navigation device 17 and the operational portion 18 of the air-conditioning unit 39 are provided above a shift lever 45 which is disposed beside the driver's seat, so that the navigation device 17 and the operational portion 18 can be located between the steering wheel 3 which the driver grips while driving and the sift lever 45 which is operated at need. Thus, the operations by the driver can be conducted easily and properly.

Also, the center console portion 2 is provided so as to project upward in the mountain shape in the side view so as to have the mountain-shaped portion 37 in such a manner that the front-upper end portion connects to the rear end of the instrument-panel recess portion 25. Thereby, the inner space with the large volume can be formed at the lower portion below the mountain-shaped portion 37, so that the various onboard devices such as the navigation device 17 may be disposed properly by using the inner space of this mountain-shaped portion 37.

That is, the center console portion 2 has the rear wall face 15a which extends obliquely rearward and downward, and the navigation device 17 as the onboard device which is of the substantially rectangular parallelepiped shape is disposed in the central console portion 2 along the rear wall face 15a. Thereby, the navigation device 17 can be disposed easily in such a manner that its display is inclined so as to be seen properly, preventing a gape from existing between the navigation device 17 and the center console portion 2. Further, by disposing the speaker 40 of the audio device in the central console portion 2 before the navigation device 17 and disposing the ventilation duct 44 of the air-conditioning unit 39 in back of the speaker 40, various onboard devices may be disposed effectively by using the inner space of the mountain-shaped portion 37.

In particular, in case the air-conditioning unit 39 is disposed in the inner space of the instrument panel at the intersection portion of the instrument panel body 1 and the center console portion 2, that is, at the central portion of the instrument panel in the vehicle width direction like the present embodiment, the common layout of the air-conditioning unit 39 can be provided regardless of the kind of vehicles with the left-side-disposition steering wheel for Europe markets or vehicles with the right-side-disposition steering wheel for Japanese markets. Thus, commonality of the instrument panel device can be improved effectively.

Further, the slot portion 26 for the SD card, the connector 27 of the portable audio device, or the store portion as the onboard functional portion are provided at the left-side (driver's side) half portion 23a of the portion of difference in level 23 which is located in front of the meter cluster portion 4. Thereby, the specified portion of the portion of difference in level 23 of the instrument-panel recess portion 25 which is located at the position which overlaps with the meter cluster portion 4 in the elevation view can be used effectively, so that the use efficiency of the instrument panel space can be improved.

The portion of difference in level 23 of the instrument-panel recess portion 25 has the different design from the surrounding part of the upper face portion 7 of the instrument panel body 1. Thereby, the sporty feeling can be provided to the driver more effectively, for example, by improving the design effect of the vehicle compartment.

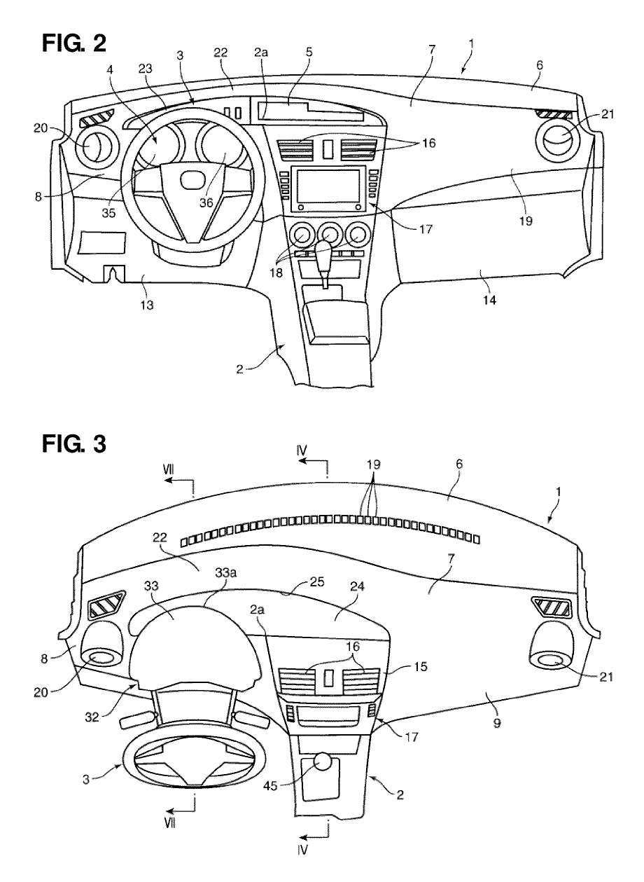

Further, the instrument-panel protrusion portion 22 has the peak point which is the highest of the upper face portion 7 of the instrument panel body 1, and the display indication portion 5 is located substantially on the center side of the vehicle compartment from the peak point of the instrument-panel protrusion portion 22 as shown in FIG. 2. Thereby, the display indication portion 5 can be located on the side of the passenger seat close to the steering wheel 3 so that the driver can see more properly the display indication portion 5.

Further, the instrument-panel rearward-slant-face portions 8, 9 are provided at the upper face portion of the instrument panel body 1 so as to gently slant rearward over the substantially whole area of the upper face portion 7 of the instrument panel body 1 in the vehicle width direction in such a manner the central portion thereof extends rearward the most. Herein, the central portion of the instrument-panel rearward-slant-face portions 8, 9 is connected to the center console portion 2 which comprises the operational portion 18 of the air-conditioning unit 39, and the display indication portion 5 is provided at a specified portion (the right-side half portion 23b) of the portion of difference in level 23 which is located substantially in front of the center console portion 2, the display indication portion 5 pointing to the driver's seat side in the plan view. Thereby, an inner space and an upper space of the instrument panel, particularly, the central portion of the instrument panel can be ensured properly, without improperly limiting spaces for the driver's seat and the passenger's seat. Thus, various onboard devices can be disposed by effectively using the inner space of the instrument panel, and the display indication portion 5 and the like can be disposed at a proper position by effectively using the upper space of the instrument panel.

Further, the air-conditioning unit 49 is stored right below the display indication portion 5, and the onboard device, such as the navigation device 17, is disposed right behind the air-conditioning unit 39 at a position which overlaps with the air-conditioning unit 39 in the elevation view. Thereby, the air-conditioning unit 49 and another onboard device such as the navigation device 17 can be disposed efficiently, by using the relatively large volume of the inner space formed below the instrument panel.

Further, the portion of difference in level 23 of the instrument-panel recess portion 25 and the center console portion 2 form the designed face, which is of the substantially reverse-J shape, which extends continuously from the driver's-seat-side portion to the center console portion 2 beyond the central portion of the instrument-panel recess portion 23 in such a manner that the portion of difference in level 23 of the instrument-panel recess portion 23 projects forward in the plan view. Thereby, the driver who drives the vehicle looking at the front X can see the information indicated at the display indication portion 5 and the display information of the navigation device 17 provided at the upper portion 15 of the center console portion 2 and the like continuously and properly by moving the driver's eyes from the side portion to the lower portion (see the arrow Y) as shown in FIG. 11, so that the driver can properly operate the operational portion of the onboard device, i.e., various operational switches of the navigation device 17 and the operational portion 18 of the air-conditioning unit 39.

### Embodiment 2

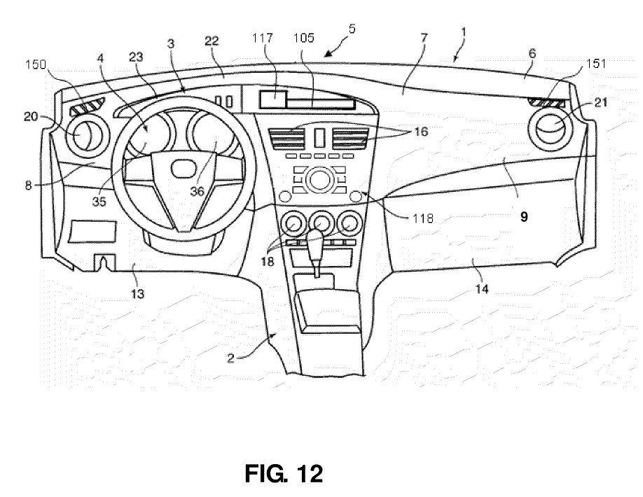

An instrument panel device according to a second embodiment of the present invention will be described referring to FIGS. 12 through 19. Herein, the same component elements as the first embodiment are denoted by the same reference characters, descriptions of which are omitted.

In the second embodiment, as shown in FIGS. 12 and 17, a navigation device 117 is provided at the display indication portion 5 in addition to a liquid-crystal indication portion 105 to indicate information relating to the onboard devices such as the air-conditioning unit 39 and the audio device. The navigation device 117 with a relatively large volume is disposed at a driver's-seat-side portion of the right-side half portion 23b of the portion of difference in level 23. The liquid-crystal indication portion 105 with a relatively small volume is disposed at a passenger's-seat-side portion of the right-side half portion 23b of the portion of difference in level 23. An operational portion 118 which comprises operational switches of the air-conditioning unit 39, the audio device and so on is provided at the center condole portion 2 at a portion right below the vent grill 16.

Further, a pair of vents for demister 150, 151 which restrains the side glass from becoming clouded up to improve the visibility is provided at the instrument panel body 1 in addition to the vent for defroster 19. The pair of vents for demister 150, 151 is disposed at portions of the rearward-slant-face portions 8, 9 which are above the vents 20, 21, respectively, and they supply the conditioning air to side portions in the vehicle compartment.

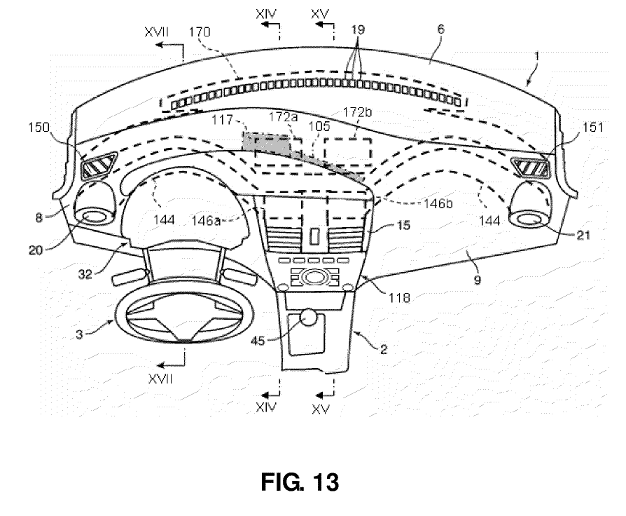

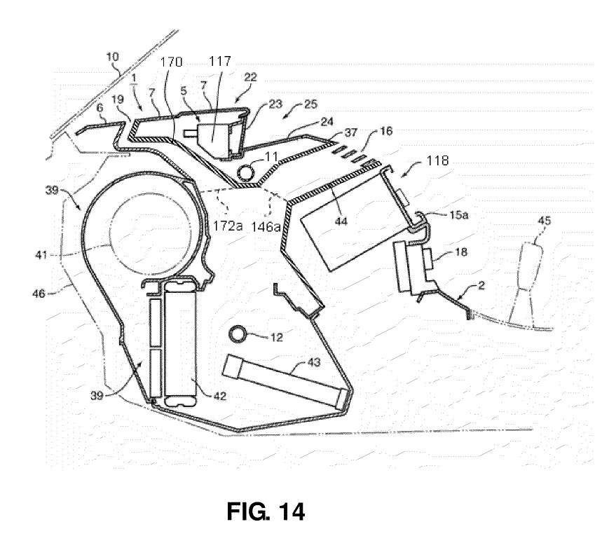

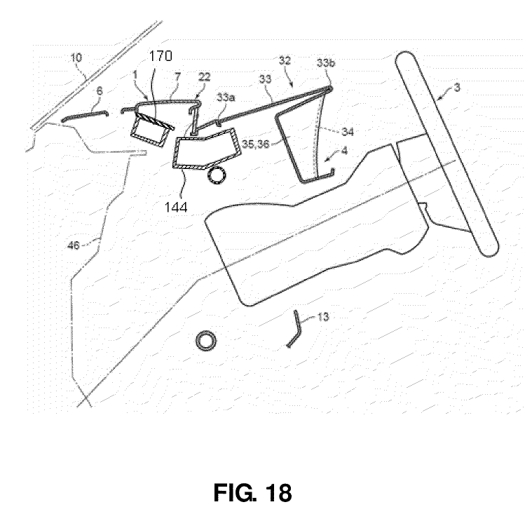

A defroster duct 170 to supply the conditioning air to the vent for defroster 19 and the vents for demister 150, 151 is provided at a portion of the instrument panel body 1 which is located in front of the ventilation duct 44, as shown in FIG. 13. The defroster duct 170 extends in the vehicle width direction at a front portion of the instrument panel body 1 as shown in FIG. 13. The defroster duct 170 extends below the instrument-panel protrusion portion 22 so as to have a large volume, as shown in FIGS. 14 and 18.

A pair of defroster openings 172a, 172b is formed at a bottom portion of the defroster duct 170 so as to penetrate vertically at the central portion in the vehicle width direction. The air-conditioning unit 39 is disposed below the defroster duct 170. The conditioning air from the air-conditioning unit 39 is supplied into the defroster duct 170 from the defroster openings 172a, 172b, and then supplied into the vent for defroster 19 and the vents for demister 150, 151.

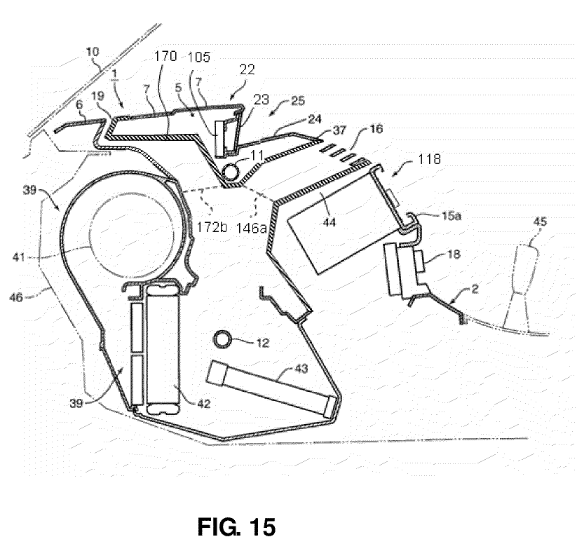

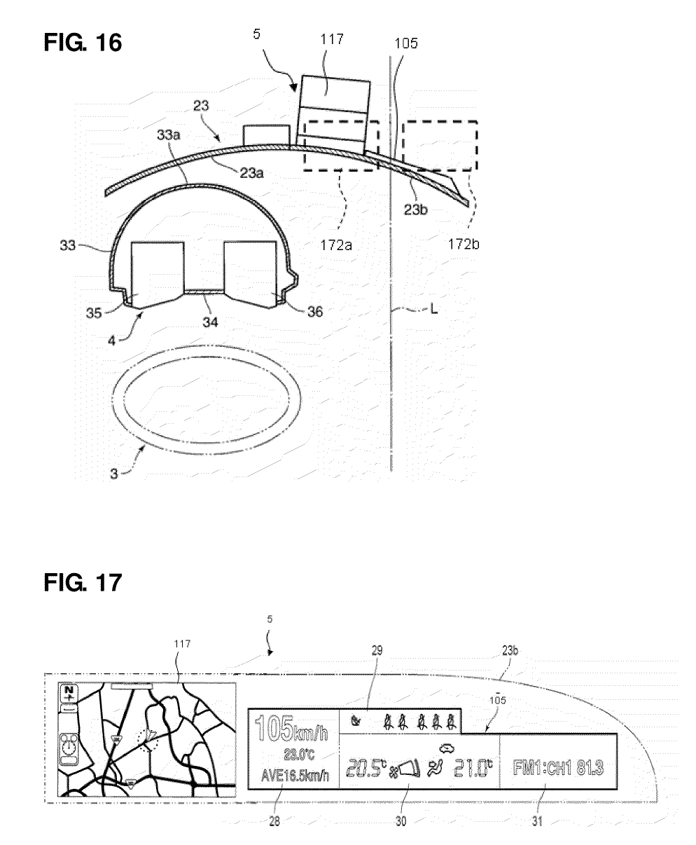

The defroster openings 172a, 172b are formed in front of the center console portion 2 below the right-side half portion 23b of the portion of difference in level 23. Specifically, as shown in FIG. 16, the driver's-seat-side defroster opening 172a is provided below the navigation device 117 which is provided at the driver's-seat-side portion of the right-side half portion 23b of the portion of difference in level 23. Meanwhile, the passenger's-seat-side defroster opening 172b is provided below the liquid-crystal indication portion 105 which is provided at the passenger's-seat-side portion of the right-side half portion 23b of the portion of difference in level 23. Herein, the longitudinal thickness of the liquid-crystal indication portion 105 is thin. A front end of the passenger's-seat-side defroster opening 172b is located in front of a front end of the liquid-crystal indication portion 105. A part of the passenger's-seat-side defroster opening 172b does not overlap with the liquid-crystal display indication portion 105 in the plan view. Thereby, the height of the defroster duct 170 can be made great (high) at its non-overlapping portion. Thus, since the height of the defroster duct 170 is ensured at the non-overlapping portion as shown in FIG. 15, the flowing resistance of the conditioning air at the defroster opening 172b can be reduced.

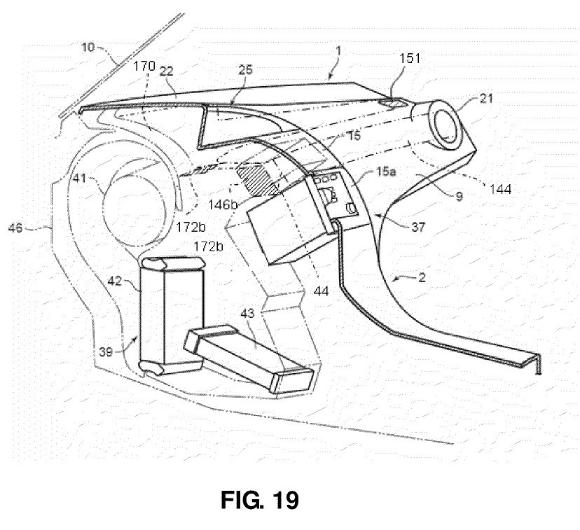

Ventilation ducts for vent 144 are provided at the instrument panel body 1 so as to connect to the above-described ventilation duct 44 which interconnects the air-conditioning unit 39 and the vent grill 16 and to supply the conditioning air to the side vent 20, 21 as shown in FIGS. 13 and 19.

A pair of vent openings 146a, 146b is formed at the bottom portion of the ventilation duct 44 so as to penetrate a specified portion vertically which is located in back of the defroster openings 172a, 172b and below the center console portion 2. The conditioning air from the air-conditioning unit 39 is supplied to the ventilation duct 44 via the ventilation openings 146a, 146b and then supplied to the vent grill 16. The conditioning air is also supplied to the side vents 20, 21 from the ventilation duct 44 via the ventilation ducts for vent 144.

The ventilation ducts for vent 144 extend laterally from specified portions of the ventilation duct 44 near the defroster openings 172a, 172b. The ventilation ducts for vent 144 on the driver's seat side extends forward from the specified portion near the defroster opening 172a, below the portion of difference in level 23 provided at the front portion of the meter cluster portion 4, and then to the side vent 20, having a curve shape along the curve portion 33a of the meter hood portion 33. Herein, the instrument-panel protrusion portion 22 protruding upward is formed in front of the portion of difference in level 23, so that a properly large space is formed below the instrument-panel protrusion portion 22 and the portion of difference in level 23. The navigation device 117 and the liquid-crystal indication portion 105 are disposed in front of the portion of difference in level 23. Thus, the ventilation ducts for vent 144 are disposed below the portion of difference in level 23, as shown in FIG. 18, so that they can have a sufficient volume without interfering with the navigation device 177 and the liquid-crystal indication portion 105. Further, the ventilation ducts for vent 144 are disposed so as not to interfere with the meter cluster portion 4 in front of the meter cluster portion 4.

According to the present embodiment, the vent for defroster 19 is provided at the front portion of the upper face portion 7 of the instrument panel body 1, the air-conditioning unit 39 is stored right below the display indication portion 5, and the defroster openings 172a, 172b which supply the conditioning air from the air-conditioning unit 39 to the vent for defroster 19 are formed at the instrument panel body 1 in such a manner that at least a part of the defroster opening 172b on the passenger's seat side does not overlap with the display indication portion 5 in the plan view. Thereby, the flow of conditioning air can be made smooth, preventing the conditioning air passing through the vent for defroster 172b from interfering with the display indication portion 5.

That is, the defroster opening 172b is formed below the liquid-crystal indication portion 105 with the longitudinally thin thickness so that the defroster opening 172b does not overlap with the display indication portion 5 in the plan view. Thereby, the sufficient height of a specified portion of the defroster duct 170 to supply the conditioning air from the air-conditioning unit 39 to the vent for defroster 19 which is located near the defroster opening 172b can be ensured. Accordingly, the flowing resistance of the conditioning air at the defroster opening 172b can be restrained.

Further, the side vent 20 which supplies the conditioning air to the side portion of the vehicle compartment is formed at the side portion of the instrument panel body 1, and the ventilation duct for vent 144 which supplies the conditioning air from the air-conditioning unit 39 to the side vent 20 is provided so as to extend in the vehicle width direction in front of the meter cluster portion 4 and below the portion of difference in level 23. Thereby, the volume of the ventilation duct for vent 144 can be ensured properly, avoiding the interference of the meter cluster portion 4 and the display indication portion 5.

Herein, the disposition of the defroster openings 172a, 172b is not limited to the above-described structure. For example, the defroster opening 172a on the driver's seat side may be disposed so as not to overlap with the display indication portion 5 in the plan view, in addition to the defroster opening 172b on the passenger's seat side. Further, the number of defroster openings should not be limited to the above-described structure, but only one defroster opening may be provided in such a manner that a part of it does not overlap with the display indication portion 5.

Also, the specific structure of the display indication portion 5 is not limited to the above-described one. For example, the navigation device 117 may be disposed on the side of the passenger's seat, and the liquid-crystal indication portion 105 may be disposed on the side of the driver's seat. In case the navigation device 117 is disposed on the side of the passenger's seat, however, the driver can see the navigation device 117 properly without moving the driver's eyes greatly. Further, the body of the navigation device may be provided at the center console portion 2, while the simplified navigation device may be provided at the display indication portion 5.

The present invention should not be limited to the above-described embodiments, and any other modifications and improvements may be applied in the scope of a spirit of the present invention.

What is claimed is:

1. An instrument panel device, comprising:
an instrument panel body provided at a front portion of a vehicle compartment so as to project rearward and extend in a vehicle width direction;
a meter cluster portion provided in front of a steering wheel;
a display indication portion to indicate information relating to an onboard device;
an instrument-panel recess portion provided at an upper face portion of the instrument panel body, the instrument-panel recess portion comprising a bottom face portion which extends from a central portion of the instrument-panel recess portion to a driver's-seat-side end portion of the instrument-panel recess portion and a portion of difference in level which rises upward from a front end portion of the bottom face portion;
a projection portion provided in front of the steering wheel, the projection portion being formed in such a manner that a specified portion of the bottom face portion of the instrument-panel recess portion which is located in front of the steering wheel projects upward,
wherein a meter-panel face portion of said meter cluster portion is provided at said projection portion, and said display indication portion is provided at a central portion of said portion of difference in level in the vehicle width direction.

2. The instrument panel device of claim 1, further comprising an instrument-panel protrusion portion provided at the upper face portion of the instrument panel body, the instrument-panel protrusion portion forming an upper face of said instrument-panel recess portion.

3. The instrument panel device of claim 2, wherein said instrument-panel protrusion portion has a peak point which is the highest of the upper face portion of the instrument panel body, and said display indication portion is located substantially on a center side of the vehicle compartment from the peak point of the instrument-panel protrusion portion.

4. The instrument panel device of claim 3, further comprising an instrument-panel rearward-slant-face portion provided at the upper face portion of the instrument panel body, the instrument-panel rearward-slant-face portion being formed so as to gently slant rearward over a substantially whole area of the upper face portion of the instrument panel body in the vehicle width direction in such a manner a central portion thereof extends rearward the most, wherein the central portion of the instrument-panel rearward-slant-face portion is connected to a center console portion which comprises an operational portion of an onboard device, and said display indication portion is provided at a specified portion of said portion of difference in level which is located substantially in front of the center console portion, the display indication portion pointing to a driver's seat side in a plan view.

5. The instrument panel device of claim 4, wherein said portion of difference in level of the instrument-panel recess portion and said center console portion form a designed face, which is of a substantially reverse-J shape, which extends continuously from a driver's-seat-side portion to the center console portion beyond the central portion of the instrument-panel recess portion in such a manner that the portion of difference in level of the instrument-panel recess portion projects forward in a plan view.

6. The instrument panel device of claim 4, wherein said center console portion is provided so as to project upward in a mountain shape in a side view in such a manner that a front-upper end portion thereof connects to a rear end of said instrument-panel recess portion and an onboard device is stored therein.

7. The instrument panel device of claim 6, wherein said center console portion has a rear wall face which extends obliquely rearward and downward, an onboard device which is of a substantially rectangular parallelepiped shape is disposed in the central console portion along the rear wall face, and another onboard device is disposed in the central console portion before the onboard device which is of the substantially rectangular parallelepiped shape.

8. The instrument panel device of claim 7, wherein a speaker of an audio device is disposed at a front portion in the center console portion, a ventilation duct of an air-conditioning unit is disposed in the center console portion behind the speaker, and said onboard device which is of the substantially rectangular parallelepiped shape is disposed below the ventilation duct.

9. The instrument panel device of claim 2, wherein an onboard functional portion is provided at a specified portion of said portion of difference in level of the instrument-panel recess portion which is located at a position which overlaps with said meter cluster portion in an elevation view.

10. The instrument panel device of claim 4, wherein said portion of difference in level of the instrument-panel recess portion has a different design from a surrounding part of the upper face portion of the instrument panel body.

11. The instrument panel device of claim 4, wherein an air-conditioning unit is stored right below said display indication portion, and an onboard device is disposed right behind the air-conditioning unit at a position which overlaps with the air-conditioning unit in an elevation view.

12. The instrument panel device of claim 4, wherein a vent for defroster is provided at a front portion of the upper face portion of said instrument panel body, an air-conditioning unit is stored right below said display indication portion, and a defroster opening for supplying conditioning air from the air-conditioning unit to the vent for defroster is formed at the instrument panel body in such a manner that at least a part of the defroster opening does not overlap with the display indication portion in a plan view.

13. The instrument panel device of claim 12, wherein a part of the defroster opening vent for defroster which is located further from a driver's seat in the vehicle width direction does not overlap with the display indication portion in the plan view.

14. The instrument panel device of claim 13, wherein a navigation device is provided at a part of the display indication portion which is located closer to the driver's seat.

15. The instrument panel device of claim 4, wherein a vent to supply conditioning air to a side portion of the vehicle compartment is formed at a side portion of said instrument panel body, and a ventilation duct to supply the conditioning air from an air-conditioning unit, which is stored right below said display indication portion, to the vent is provided so as to extend in the vehicle width direction in front of said meter cluster portion and below said portion of difference in level.
